(19) United States
(12) Patent Application Publication
(10) Pub. No.: US 2008/0050063 A1
(43) Pub. Date: Feb. 28, 2008

(54) Opto-Mechanical Switching System

(76) Inventors: Marco Arioli, Valmadrera (IT); Mario Martinelli, Milan (IT); Andrea Melloni, Milan (IT); Davide Piccinin, Milan (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/791,982

(22) PCT Filed: Dec. 15, 2004
(86) PCT No.: PCT/EP04/53508

§ 371 Date: May 31, 2007

(51) Int. Cl. G02B 6/35

(52) U.S. Cl. 385/16

(57) ABSTRACT

An optical switching system includes a two-dimensional arrangement of a plurality of switching elements. Each switching element includes an optical guiding structure which includes two pairs of waveguides; a driving arrangement for individually moving the switching elements between at least a first and a second position; and a first and a second input and a second output. When a generic switching element is moved in the first position, the first pair of waveguides connects a first input with a first output, and a second input with a second output; when a generic switching element is moved in the second position, the second pair of waveguides connects the first input with the second output, and the second input with the first output. In a first embodiment, the waveguides are provided on a disc shaped carrier and lie in the same plane, which disc is rotated. In a second embodiment, the two pairs of waveguides lie in different planes and the waveguide carrier plate is moved up and down for switching.

The present invention concerns an optical switching system, which can be used in particular in optical communications. More specifically, the invention relates to an opto-mechanical switching system.

Modern communications networks are based on the employment of optical fibers in order to handle the rapidly increasing demand for higher transmission rates. However, the enormous bandwidth of the optical fibers can only be fully exploited once the networks become truly transparent to bit rates and transmission protocols. In fact, at present a conversion of optical signals into electrical signals (opto-electrical conversion) is necessary for executing a lot of operations required at network nodes and electronic interfaces lead to network nodes not transparent to the bandwidth and to the transmission bit rates.

In particular, in telecommunications the use of a component that permits to dynamically connect different communications lines (a so called cross-connect) is very important and, consequently, an optical cross-connect is one of the key elements for transparent network nodes. However, at present in an optical communications network the cross-connection, for example between the different communications lines, is not executed directly on the optical signals, but on electrical signals obtained by the opto-electrical conversion.

Typically, a cross-connect is a switching system consisting of an arrangement of switching elements (switches) dynamically controlled for routing the signals of the different communication channels towards different paths. Many types of switches have been proposed, such as switches based on the specific optical properties of some materials; for example, electro-optical switches exploit the Pockels effect, while all-optical switches exploit second order optical nonlinearities, and holographic switches the photorefractive effect. Furthermore, opto-mechanical switches are based on the use of mini (micro) motors or Micro-Electro-Mechanics (shortly, MEM) for actuating a commutation by means of a specific rotational or translational movement of the switches.

An optical switch is mainly characterized by a specific switching time, insertion losses, cross talk between the communication channels and polarization dependent losses. For most switching purposes (as in switched circuit communication networks) the relatively high switching time of the opto-mechanical switches (in the range from 10 ms to some 100 ms) is considered adequate and, consequently, in many applications the opto-mechanical switches are preferred because of the simpler implementation, the lower fabrication costs and the easier controllability thanks to the use of standard technologies.

In general, in an opto-mechanical switching system the optical signals are propagated either in free space, by multiple reflections onto micro mirrors or by multiple deviations by prisms, or in optical guiding structures, by multiple couplings into different optical waveguides or fibers.

An example of free-space cross-connect is described in A. C. M. Ruzzu et al., “Optoelectromechanical Switch Array With Passively Aligned Free-Space Optical Components”, Journal of Lightwave Technology, vol. 12, No. 3, Mar. 2003, p. 664-671. This free-space cross-connect includes an array of movable micro mirrors and the optical signals (provided by a plurality of input optical fibers) undergo multiple reflections for being routed towards output optical fibers; the different controlled orientations of the micro mirrors permit the propagation along desired optical paths between the input optical fibers and the output optical fibers.

The Applicant has observed that a free-space cross-connect has many problems, such as power losses and a beam waist increment in free-space propagation, and polarization dependent losses due to the angle dependence of the reflectivity of the transverse electric and transverse magnetic modes. The power losses and the beam waist increment in free-space propagation limit the scalability of the cross-connect, i.e. the length of the optical paths inside the cross-connect and, consequently, the number of optical signals that can be routed. Furthermore, the beam waist increment can correspond to higher insertion losses in the coupling of the optical signals into the output optical fibers.

The French patent application No. 2479993 discloses an opto-mechanical switch comprising two pairs of optical fiber segments; the German patent application No. 30 12 450 proposes a further opto-mechanical switch having an optical guiding structure including two pairs of waveguides. A first pair of waveguides of the two proposed optical guiding structures deviates the direction of propagation of received optical signals, contrary to a second pair of waveguides. The optical signal from one among the waveguides of a first switch can be coupled into one among the waveguides of a second switch by causing the switches to translate.

The U.S. Pat. Nos. 5,078,514 and 5,612,815 disclose opto-mechanical switches comprising MEM devices; in detail, the switches includes an integrated optics guiding structure with a fixed part and a movable part connected to the fixed part. The movable part includes waveguides, which undergo a translational movement thanks to a deformation induced by an electrostatic transducer.

The actuation of the translational movement in those switches implies stresses of the movable part and a very critical controllability, as also recognized in the U.S. Pat. No. 5,612,815.

Considering a two-dimensional arrangement of the switches as disclosed in the French patent application No. 2479993, in the German patent application No. 30 12 450 and in the U.S. Pat. Nos. 5,078,514 and 5,612,815, a plurality of input optical fibers can be accommodated in front of a respective switch and, at the same time, a plurality of output optical fibers can collect the optical signals from respective switches. The Applicant observes that the proposed optical guiding structures do not permit the implementation of a two-dimensional arrangement of these switches that grants a flexible configuration and an easy controllability of the possible optical paths. In fact, the control of the configurations of the signal optical paths in the two-dimensional arrangements of these switches is not simple, since for obtaining a new configuration it may be required to translate most of, or even all, the switches. Furthermore, in some cases the exploitation of a free-space propagation or a guided propagation in further optical guiding structures between two switches is necessary, accordingly leading to bulky two-dimensional arrangements.

In the U.S. Pat. No. 4,653,849 an optical switching assembly is disclosed, comprising a distribution of a number P of plates and a number N of translating (rotating) switches incorporating N waveguides. Each plate receives the respective optical signal from one respective input optical fiber or waveguide and the received optical signal is coupled into all the waveguides of the plate. The switches are arranged in such a way that each waveguide of one switch receives the respective optical signal from a respective plate; the translational movement of each switch permits the optical coupling between the desired waveguide and one respective output optical fiber or waveguide for transmitting the desired optical signal thereinto. Thus, the switching assembly implements a P×N cross-connect, in which the optical signals travel through controlled guided optical paths.

The Applicant has observed that the switching assembly disclosed in that document is hardly configurable with the increase of the number N of output optical fibers, because of the complexity of a single plate or switch that comprise a great number of waveguides.

In view of the state of the art outlined in the foregoing, it has been an object of the present invention to overcome the above-mentioned drawbacks. In particular, it has been an object of the present invention to provide an optical switching system that ensures easy controllability, high scalability and, at the same time, a simple implementation.

In order to achieve this object, according to an aspect of the present invention, an optical switching system as set out in the claim 1 is proposed.

Summarizing, an optical switching system includes a two-dimensional arrangement of a plurality of switching elements adapted to routing a plurality of optical signals provided at inputs of the optical switching system towards respective outputs of the optical switching system.

Each switching element includes:

an optical guiding structure comprising two pairs of waveguides, each waveguide having an input and an output end faces;

a driving arrangement for individually moving the switching elements between at least a first and a second positions; and

a first and a second inputs couplable to said input end faces, and a first and a second outputs couplable to said output end faces, each of said first and second inputs being optically coupled to either an input of the switching system or an output of an adjacent switching element, and each of said first and second outputs being optically coupled to either an output of the switching system or an input of a further adjacent switching element.

When a generic switching element is moved in the first position, the first input is coupled to the input end face of a first waveguide of the two pairs of waveguides, and the first output is coupled to the output end face of the first waveguide, thereby an optical signal received at the first input is routed to the first output; the second input is coupled to the input end face of a second waveguide of the two pairs of waveguides, and the second output is coupled to the output end face of the second waveguide, thereby an optical signal received at the second input is routed to the second output.

When a generic switching element is moved in the second position, the first input is coupled to the input end face of a third waveguide of the two pairs of waveguides, and the second output is coupled to the output end face of the third waveguide, thereby an optical signal received at the first input is routed to the second output; the second input is coupled to the input end face of a fourth waveguide of the two pairs of waveguides, and the first output is coupled to the output end face of the fourth waveguide, thereby an optical signal received at the second input is routed to the first output.

The first, second, third and fourth waveguides are integrated optical waveguides, and the two-dimensional arrangement is a matrix arrangement with a number M of rows of switching elements and a number N of corresponding columns of switching elements, the first input of a generic switching element being optically coupled to either an input of the switching system or the first output of a switching element of a same row, and the second input of a generic switching element being optically coupled to either a further input of the switching system or the second output of a switching element of a same column.

In an embodiment of the present invention, the plurality of optical signals is provided by first optical elements, each first optical element being coupled to one respective input of the optical switching system, and the plurality of optical signals routed towards the outputs of the optical switching system is received by second optical elements, each second optical element being coupled to one respective output of the optical switching system.

Each switching element may further include one optical device coupled to at least one among the first and second end faces of the first, second, third and fourth waveguides for focusing/collimating an optical signal.

In an embodiment of the present invention, the switching system includes a further optical device coupled to at least one among the first and second optical elements for focusing/collimating an optical signal.

A control unit may be further provided for, for dynamically controlling the driving arrangement of the plurality of switching elements.

According to an embodiment of the present invention, the two pairs of waveguides of the switching elements lie in a same plane and the driving arrangement causes the optical guiding structure to rotate about an axis of the plane for moving the respective switching element between the first or the second positions.

The input and output end faces of the first, second, third and fourth waveguides of each switching element may be angularly separated of approximately 45°.

In another embodiment of the invention, the first and second waveguides of the switching elements lie in a first plane and the third and fourth waveguides lie in a second plane, the first and second planes being parallel, and the driving arrangement causes the optical guiding structure to translate perpendicularly to the two planes for moving the respective switching element between the first and the second positions.

The arrangement of the plurality of switching elements may be accommodated in a box-shaped housing, which may include grooves for receiving the first and the second optical elements.

According to another aspect of the present invention, an optical communications network node as set forth in claim 11 is provided, receiving a plurality of optical signals, each one provided to a respective input of an optical switching system, the optical switching system routing each received optical signal towards a respective output of the switching system. The optical switching system is according to the first aspect of the invention.

Further features and the advantages of the present invention will be made clear by the following description of some embodiments thereof, provided purely by way of non-limitative example, description that will be conducted making reference to the attached drawings, wherein:

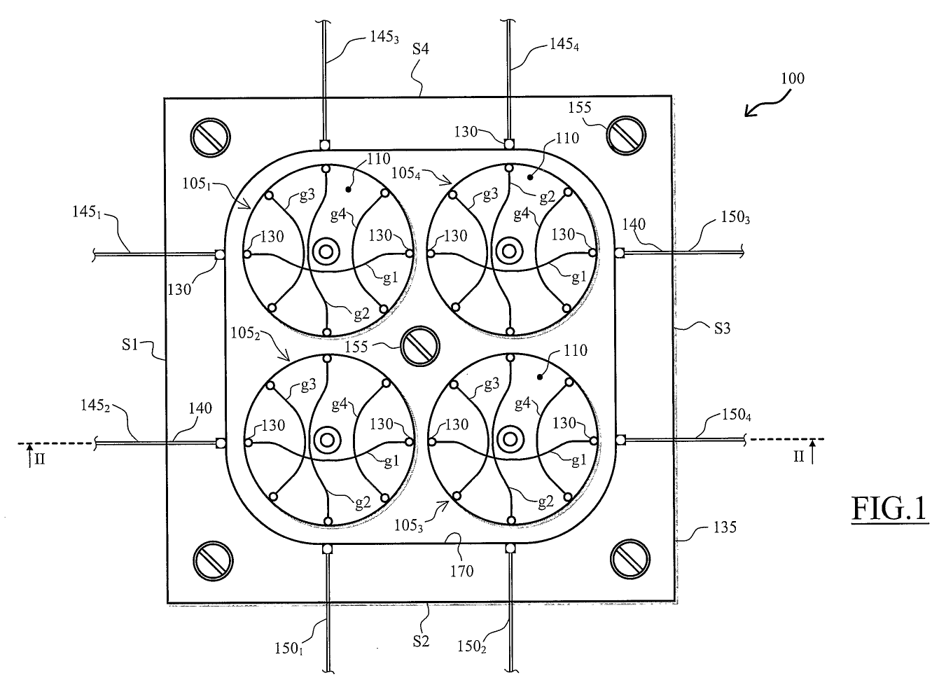

FIG. 1 is a top view of an optical switching system according to an embodiment of the present invention (without a cover);

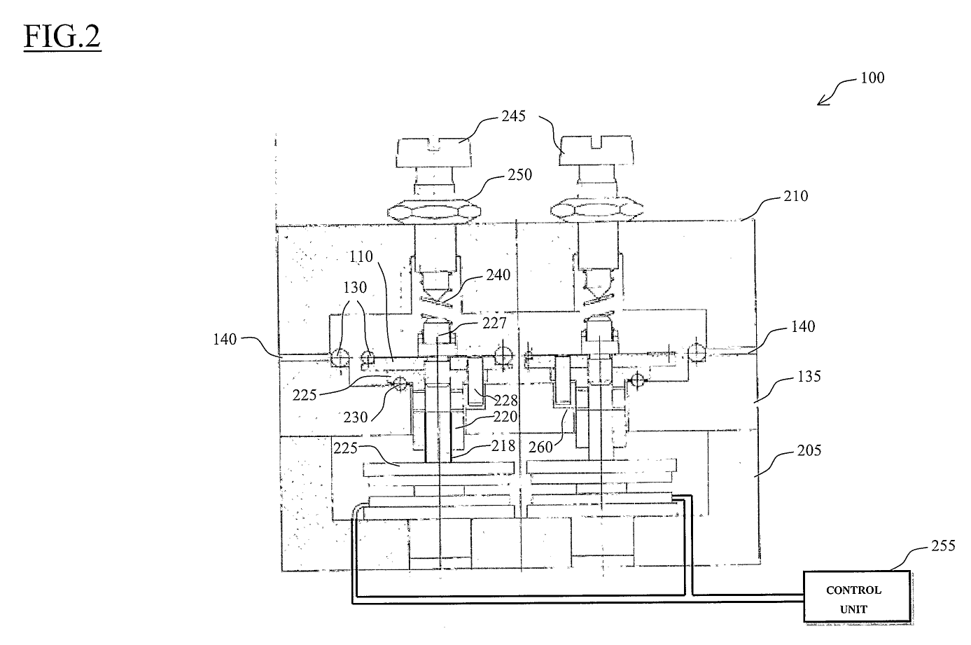

FIG. 2 is a side view of the optical switching system in cross section along line II-II of FIG. 1;

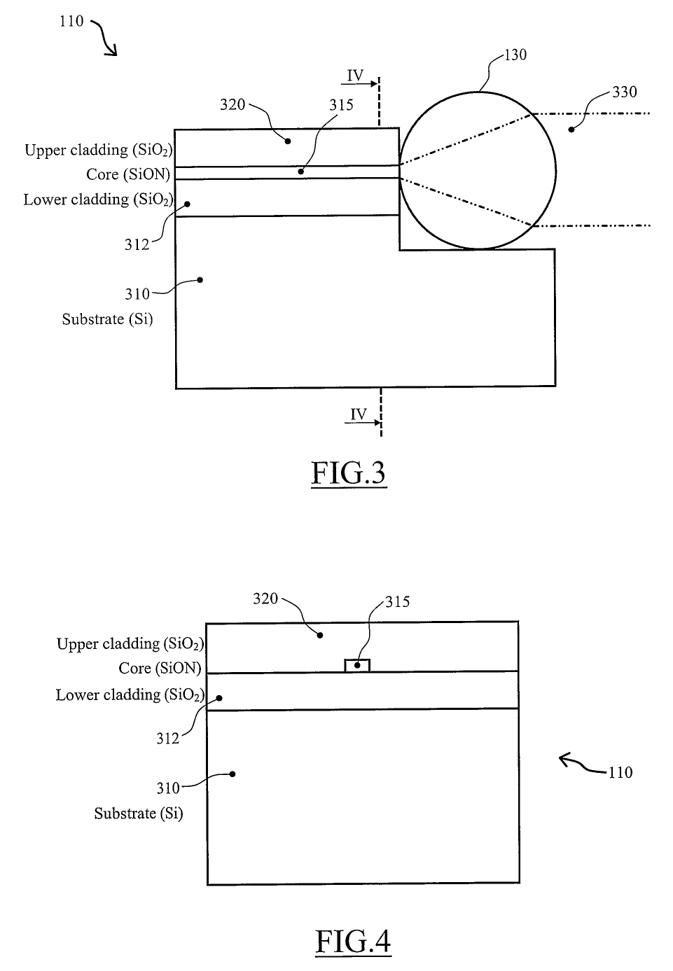

FIG. 3 shows schematically a longitudinal section of an integrated optics guiding structure of an opto-mechanical switching element exploited in the optical switching system of FIG. 1;

FIG. 4 illustrates a transverse section, along the line IV-IV, of the integrated optics guiding structure of FIG. 3;

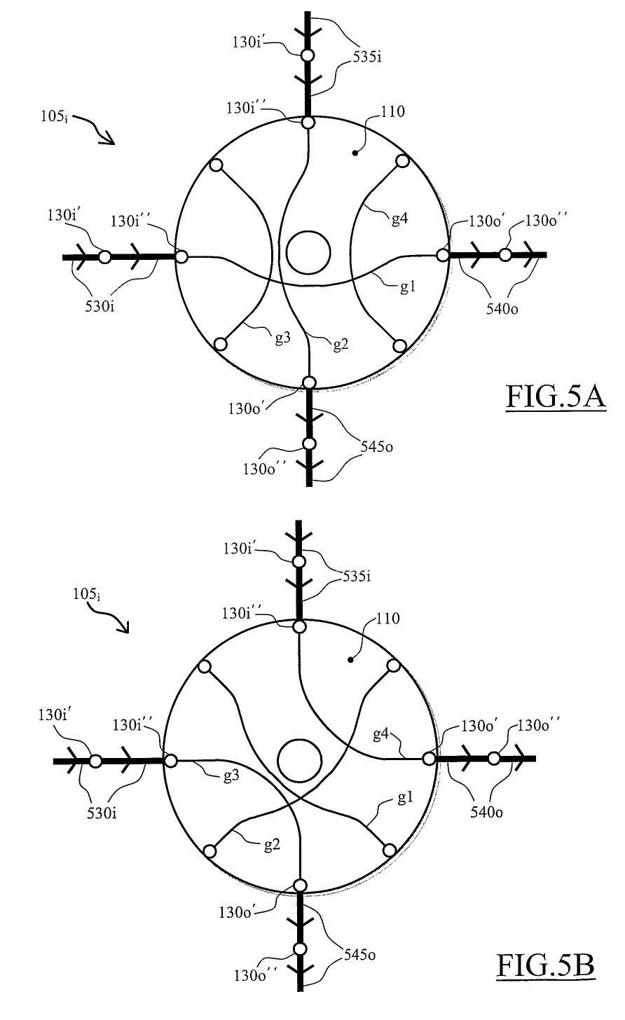

FIG. 5A is a top view of the opto-mechanical switching element in a bar configuration;

FIG. 5B is a top view of the opto-mechanical switching element in a cross configuration; and

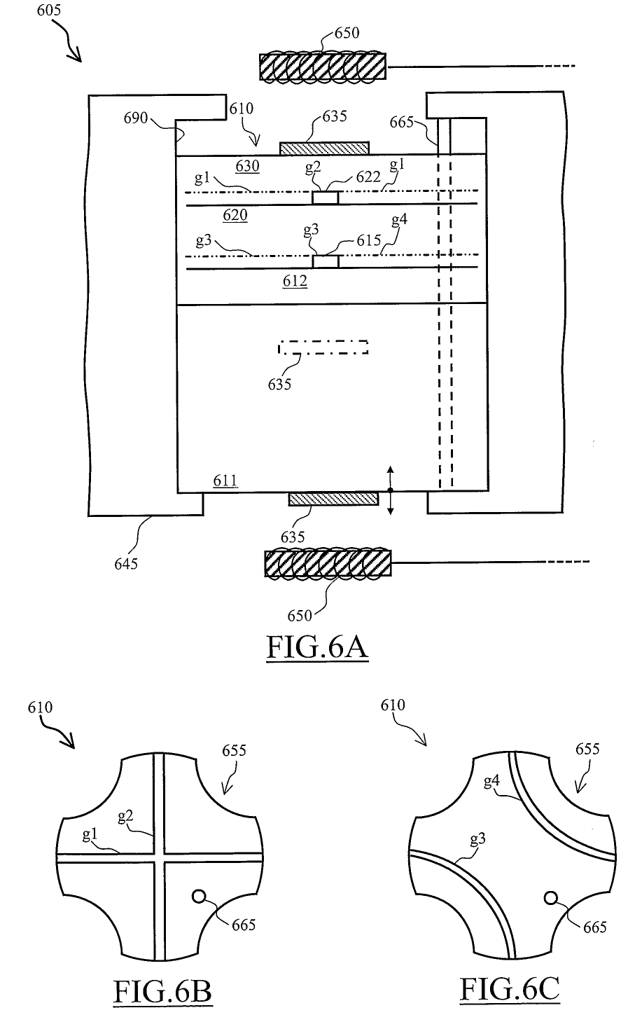

FIGS. 6A, 6B and 6C show an elevation sectional view and two top-plane views (at different heights) of an opto-mechanical switching element according to an alternative embodiment of the present invention.

Referring to the drawings, FIG. 1 is a top view of an optical switching system 100 according to an embodiment of the present invention. Albeit not limitatively, the switching system 100 can be used for dynamically routing optical signals through different optical paths, in particular in optical communication networks. For example, the optical switching system 100 can be used in optical communications networks intended to support Wavelength Division Multiplexing (shortly, WDM) optical communications, in which case the switching system 100 can be used for dynamically routing optical signals transported through respective WDM channels.

The switching system 100 includes a two-dimensional arrangement, or an M×N matrix, of opto-mechanical switching elements (hereinafter simply referred to as switches) 105ᵢ, with i=1, . . . ,M×N; for the sake of simplicity, in the present description it is supposed that M=N=2 so that the switching system 100 comprises four switches 105₁-105₄. Each switch 105ᵢ comprises a disk-shaped element (hereinafter referred to as disk) 110, e.g. of silicon, with a diameter, for example, roughly from 6 to 10 mm, carrying an integrated optics guiding structure.

The generic switch 105ᵢ further includes a driving mechanical arrangement (not visible in FIG. 1, but shown schematically in FIG. 2) for causing a rotation of the switch 105ᵢ about the axis thereof (as described in detail in the following).

The integrated optics guiding structure of the switches 105ᵢ includes four waveguides g1, g2, g3 and g4, particularly coplanar waveguides, for implementing 2×2 switches (i.e., switches with two inputs and two outputs). Each waveguide g1-g4 has a first end face and a second end face disposed on the outer peripheral edge of the disk 110. In particular, the waveguides g1 and g2 have the first and the second end faces at the opposite extremes of two mutually orthogonal diameters of the disk 110. Each waveguide g3, g4 has the first and the second end faces at the extreme of two respective radii of the disk 110 forming an angle of approximately 90°. In addition, the radius corresponding to the first end face of the waveguide g1 and the radius corresponding to the first or the second end faces of the waveguide g4 form an angle of approximately 45°; the radius corresponding to the second end face of the waveguide g1 and the radius corresponding to the first or the second end faces of the waveguide g3 form an angle of approximately 45°. Consequently, the waveguide g1 is intersected by the waveguides g2, g3 and g4. Furthermore, the central part of the waveguides g1 and g2 is bent, for going round a central hole in the disk, having for example a diameter of about 1 mm, while the central part of the waveguides g3 and g4 is bent for smoothly joining the two ending parts thereof.

The bending radius of the bent part of the waveguides g1, g2, g3 and g4 depends on the refractive index contrast of the integrated optics guiding structure; for example, with a relatively high refractive index contrast of roughly 4.5% the bending radius can be of the order of a millimeter (for example, of about 1-1.2 mm). Accordingly, the size of the disk 110 depends on the value of the bending radius and, then, on the value of the refractive index contrast. In addition, the physical dimensions of the driving arrangement (e.g., minimotors) may affect the size of the disk.

Spherical lenses 130 (for example, of glass or even of a plastic material), hereinafter referred to as ball lenses 130, are placed into respective seats provided in the disk 110, in front of a respective first or second end faces of the waveguides g1, g2, g3 and g4. Consequently, the ball lenses 130 of the switches 105ᵢ are arranged in such a way that the radii of the disks 110 corresponding to two consecutive ball lenses 130 form an angle of approximately 45°. The ball lenses 130 can have a diameter of about few hundreds of micrometers (for example, 150-300 μm) and a refractive index roughly in the range from 1.46 to 2. The ball lenses 130 focus the optical beams into, or collimate the optical beams received from, the waveguides g1, g2, g3 and g4. The ball lenses 130 are held in place within the respective seats, being fixed to the disk 110 by an appropriate adhesive compound (such as a resin).

A frame 135 (for example, of steel or of silicon) is adapted to supporting the M×N matrix of switches 105ᵢ; the frame 135 has at least M grooves 140 on a first side S1 thereof and at least N grooves 140 on a second side S2, consecutive to the first side S1. Preferably, the frame 135 has also at least M grooves 140 on a third side S3, opposite to the first side S1, and at least N grooves 140 on a fourth side S4, opposite to the second side S2. The grooves 140 are adapted to accommodating an optical fiber 145i, 150i and are arranged in such a way that optical fibers 145ᵢ, 150ᵢ can be aligned with the waveguides g1-g4 of respective switches 105ᵢ.

Input single mode optical fibers 145₁, and 145₂ are accommodated and fixed inside the respective grooves 140 of the first side S1; preferably, further input single mode optical fibers 145₃ and 145₄ are accommodated and fixed inside the respective grooves 140 of the fourth side S4 of the frame 135. An input fiber 145₁ is placed on the first side S1 of the frame 135 and an input fiber 145₃ is placed on the fourth side S4 both in front of a switch 105₁; an input fiber 145₂ is placed on the first side S1 in front of a switch 105₂ and an input fiber 145₄ is placed on the fourth side S4 of the frame 135 in front of a switch 105₄.

Output single mode optical fibers 150₁ and 150₂ are accommodated and fixed within the respective grooves 140 of the second side S2 of the frame 135; output single mode optical fibers 150₃ and 150₄ are accommodated and fixed within the respective grooves 140 of the third side S3 of the frame 135, opposite to the first side S1. The output fibers 150₁ and 150₂ are placed in front of the switch 105₂ and the switch 105₃, respectively; the output fibers 150₃ and 150₄ are placed in front of the switch 105₄ and the switch 105₃, respectively.

Along an internal edge 170 of the frame 135, seats adapted to containing further ball lenses 130 are provided at the end of each groove 140; these further ball lenses 130 are exploited for focusing the optical beams into, or for collimating the optical beams received from, the optical fibers 145₁-150₄ positioned in the grooves 140. These ball lenses 130 are aligned with the longitudinal axis of the groove 140 (i.e., the longitudinal axis of the optical fiber 145₁-150₄) and can face the ball lenses 130 of the switches 105ᵢ.

Furthermore, the arrangement of the switches 105ᵢ is such that the ball lenses 130 of a switch 105ᵢ can face the ball lenses of adjacent switches 105ᵢ and of the frame 135. The distances between two aligned ball lenses 130 are preferably of the order of few tens of micrometers, so as to limit the free-space path of the optical beams and consequent losses.

The frame 135 is provided with a threaded hole at each corner and at the center thereof, and screws 155 are used for fixing the frame to a support (not visible in FIG. 1).

The Applicant observes that a switch comprising an integrated optics guiding structure is preferable than an opto-mechanical switch comprising optical fiber segments for saving of occupied area, for example, inside a network node. In addition, the integrated optics permits to exploit automated fabrication processes, thus bringing to cut production costs.

Similar considerations apply if the element carrying the integrated optics guiding structure of the switches has a different shape (i.e., not necessarily the shape of a disk). The waveguides may have an alternative pattern, e.g. their end faces may be angularly separated of different angles. Furthermore, the arrangement of the switches may be different, for example, the switches may be arranged in lines along a first direction and along a second direction, the first and second direction being not orthogonal. The grooves in the frame for the optical fibers can have an alternative arrangement, according to the architecture of the arrangement of the switches. The optical fibers fixed into the grooves can be of different type and can be in a different number, i.e., only a fraction of the grooves can accommodate optical fibers. Furthermore, alternative optical waveguide may be used in place of optical fibers, or the optical signals may be coupled into the integrated waveguides of the switches after a free-space path.

Alternatively, the lenses for focusing or collimating the optical beams are of different type, or they may be dispensed for, e.g., when the waveguides are properly tapered or other beam collimating solutions are realized at their end portions, or when the switches are immersed in a matching fluid. For example, also Fresnel or GRaded INdex (GRIN) lenses can be used; preferred solutions include the use of hemi-spherical lenses fixed to the end faces of the waveguides with their flat surface. The exploited lenses can have different sizes and a different refractive index depending on the switching system architecture and on the integrated optics guiding structure (or on an arrangement of optical fiber segments).

It has to be pointed out that the switching system according to the present invention can be exploited in general in applications in which optical signals need to be routed through different optical paths. In addition, the switching system according to the present invention is transparent to the received optical signal, and, particularly, to the bit rate and to the transmission protocols.

Considering now FIG. 2, a side view of the switching system 100 is schematically illustrated in cross section along line II-II of FIG. 1 (the elements corresponding to those depicted in FIG. 1 are denoted with the same reference numerals and their description is omitted for the sake of simplicity). The frame 135 leans onto a support 205, and a cover 210 is placed and fixed (in a way to be described later on) onto the frame 135.

The driving mechanical arrangement of each switch 105ᵢ comprises a small electric motor 215, here referred to as minimotor 215, fixed to the support 205; the minimotor 215 actuates the rotational movement of a relatively small shaft 218, such as to insert into the central hole of the disk 110, e.g. of a diameter of about 1 mm. A coupling joint 220 joins the end of the shaft 218 and a rotary table 225 for transmitting the rotational movement thereto. A ball bearing 230 between the rotary table 225 and the frame 135 supports and guides the rotary table 225 so as to ensure that the rotational movement is planar. The disk 110 is placed onto the rotary table 225 in such a way that the axis of the shaft 218 coincides with the axis of the disk 110 and the disk 110 may revolve according to the rotation of the shaft 218 about the axis thereof.

A pushing pin 227 is inserted into the central hole of the disk 110 and into a central hole of the rotary table 225; a bias spring 240 pushes the pin 227 downwards, so that the pushing pin 227 can press the disk 110 onto the rotary table 225, ensuring that the disk 110 moves together with the mechanical arrangement during a rotation. The vertical pushing action of the bias spring 240 is adjusted by a screw 245 inserted into the cover 210 and stopped by a nut 250; the head of the screw 245 and the nut 250 are external to the switching system 100.

A guide pin 228 projects from the rotary table 225 for limiting the rotation of the switches 105ᵢ to desired angles. The guide pin 228 slides within an arc-shaped groove 260 formed in the frame 135, corresponding to an arc of a circumference concentric to the disk 110.

The guide pin 228 cooperates with the two end walls of the respective arc-shaped groove 260 for angularly limiting the rotational movement of the switch 105ᵢ. The length of the arc-shaped groove 260 is such that, when the movement of the guide pin 228 is stopped by either one or the other of the end walls of the groove 260, four ball lenses 130 of the switch 105ᵢ are positioned so as to face corresponding ball lenses 130 of the adjacent switches 105ᵢ and of the frame 135. Each guide pin 228 allows the switch 105ᵢ, and consequently the disk 110, rotating of at most an angle of approximately 45° about the axis thereof. Alternatively, the arc-shaped groove 260 is longer and the guide pin 228 allows the disk 110 rotating of at most an angle of approximately 135°.

The minimotors 215 are controlled by a control unit 255 (shown only schematically in FIG. 2), which controls the relative position of the switches 105ᵢ and actuates the rotation, when required, for properly configuring the switching system 100. Consequently, by means of the control unit 255 it is possible to directly control the optical path of an optical signal inside the switching system 100. By exploiting commercially available minimotors 215 (e.g. an EC 6 maxon EC motor model) it is possible to reach a switching time of the order of milliseconds (for example, five milliseconds) depending also on the size of the disk 110.

Alternative embodiments may provide that the mechanical drive arrangement has a different structure and the disk is fixed onto the rotary table by means different than the pushing pin and the bias spring; furthermore, the rotational movement of the switch may be limited by a device different than a guide pin sliding within a groove. Similar considerations apply if Micro-Electro-Mechanical elements (MEM) are integrated with the disk in place of the mechanical arrangements driven by the minimotors.

With reference to FIG. 3, a longitudinal section of the integrated optics guiding structure integrated on the disk 110 is schematically shown. The integrated optics guiding structure of the disk 110 is obtained, for example, by a known fabrication process, consisting of different stages, which will be briefly discussed in the following.

The integrated optics guiding structure is formed, preferably, on a silicon (Si) substrate 310 of the disk 110, having a thickness of about 600 μm. Directly laying on the substrate 310 the integrated optics guiding structure presents, for example, a silica (SiO₂) lower cladding layer 312 of thickness in the range from about 7 to about 15 μm, over which a silicon oxinitride (SiON) core 315 of thickness of about 1.8-2.5 μm leans. A silica upper cladding layer 320 of thickness in the range from about 7 to about 15 μm covers the whole integrated optics guiding structure.

In front of an end face of the core 315 a seat for a ball lens 130 is etched in the silicon substrate 310 in such a way that the longitudinal axis of the core 315 is substantially aligned to an axis of the ball lens 130; consequently, the ball lens 130 can focus (collimate) an optical beam 330 into (received from) the core 315.

However, the integrated optics guiding structure can be fabricated by different planar technologies exploiting alternative material, both crystalline and amorphous, assuring a suitable refractive index contrast and, where necessary, the possibility of etching the seats for the lenses. Alternatively, when a high refractive index difference is not necessarily required, commercially mature planar technologies relying on a low index contrast typically of about 0.75% can also be exploited. For example, the waveguides can be Ge-doped silica waveguides having an index contrast ranging from relatively low values, such as 0.7%, to higher values, such as 3.5%; alternative waveguides can be obtained also by deposition of Ge Boron-Silicate Glass (GeBSG), adapted to implement waveguides with a relatively high index contrast, such as 4.5%.

Considering now FIG. 4, a transverse section, along line IV-IV of FIG. 3, of the integrated optics guiding structure integrated on the disk 110 is schematically illustrated (the elements corresponding to those depicted in FIG. 3 are denoted with the same reference numerals and their description is omitted for the sake of simplicity). In particular, the SiON core 315 presents a rectangular section of width of about 2-2.5 μm.

The principal stages of an exemplary fabrication process for the formation of the integrated optics guiding structure are described hereinbelow with reference both to FIG. 3 and FIG. 4.

The fabrication process is executed on a silicon wafer typically having a thickness of 600 μm. Preferably, for obtaining the lower cladding 312 of the guiding structures, about 7-15 micrometers of the thickness of the silicon substrate 310 undergo a thermal oxidation or a SiO₂ layer of the same thickness is deposited by other standard processes; in this way, the wafer presents a layer of silica directly laying on the silicon substrate 310. Successively, an upper layer, for example, of SiON of about 1.8-2.5 μm is formed, e.g. by a Plasma-Enhanced Chemical Vapor Deposition (PECVD) process (other techniques being possible, particularly other chemical processes or, for example, also thermal processes).

SiON permits the implementation of a guiding structure with a relatively high refractive index difference between the core 315 and the lower cladding 312 of about 4.5% (typically, a high index contrast is higher than 2.5% and preferably lower than 10%). The bending losses in a guiding structure increase for shorter bending radius, but decrease for higher refractive index difference. Thanks to the use of SiON, an optical guiding structure with an index contrast of about 4.5% can have a bending radius of, for example, 1-1.2 mm and resulting bending losses of about 0.01 dB/mm. Preferably, the size and the refractive index difference of the waveguides are chosen in such a way as to ensure the monomodality of the waveguides.

The definition of the waveguide patterns in the SiON layer is made by means of a photolithographic process; a layer of photo-resist is deposited over the whole wafer, a mask is aligned with the wafer, and then the wafer is exposed to a suitable radiation for defining the waveguide patterns. The exposed photo-resist is developed and selectively removed, and SiON (or, in general, the material exploited for implementing the core of the waveguides) in excess with respect to the waveguide pattern is etched away. The etching of the SiON brings preferably to a rectangular transverse section of the core 315, as shown in FIG. 4.

Successively, a silica layer 320 is deposited onto the wafer, e.g. using a Chemical Vapor Deposition (shortly, CVD) process, for example a PECVD process.

Finally, a center narrow hole and the seats for the ball lenses 130 (not visible in the drawings) is obtained, preferably, by a further photolithographic process exploiting a dry etching.

It is observed that alternative fabrication processes, as well as alternative materials can be used, for example, for producing semiconductor waveguides. For example, GeBSG can be deposited by a Low Pressure CVD process in place of SiON and BSG in place of SiO₂ (obtaining an index contrast up to about 5%). Alternatively, also the silica lower cladding can be obtained by a CVD process instead of thermal oxidation of the silicon substrate. Those skilled in the art will recognize that the size of the waveguides varies accordingly to the refractive index contrast.

FIG. 5A is a top view of the switch 105ᵢ in a so-called bar configuration. An input optical signal is provided to the switch 105ᵢ by one of the waveguides g1-g4 of an adjacent switch 105ᵢ, or by an input fiber 145₁-145₄ (not shown in the drawing); in the bar configuration, the input optical signal is coupled into the waveguides g1 and/or g2.

In detail, an optical beam 530i carrying a first input optical signal is collimated by a first input ball lens 130i′ placed in front of the end of a waveguide g1, g4 of an adjacent switch 105ᵢ or of an input fiber 145₁, 145₂. After a short free-space path, since in the bar configuration the first input ball lens 130i′ is aligned with the longitudinal axis of the waveguide g1, the beam 530i is focused by a second input ball lens 130i″, placed in front of the first end face of the waveguide g1 of the switch 105ᵢ and the input optical beam 530i is coupled into the waveguide g1 (fiber-to-waveguide coupling or waveguide-to-waveguide coupling). Similarly, an input optical beam 535i carrying a second input optical signal can be simultaneously coupled into the waveguide g2 by means of the alignment between the waveguide g2 and a further input ball lens 130i′, and by another input ball lens 130i″ placed in front of the end of waveguide g2.

The coupled optical signal travels through an in-waveguide path g1, g2 inside the disk 110 towards the second end face of the waveguide g1, g2. Output optical beams 540o and 545o, carrying first and second output optical signals corresponding to the first and second input optical signals, are collimated by first output ball lenses 130o′ placed in front of the second end faces of the waveguides g1 and g2, respectively. After a further, short free-space path, the output beam 540o is focused by a second output ball lens 130o″, coinciding with a first input ball lens 130i′ in front of the waveguide g1 or g3 of the adjacent switch 105ᵢ or, in case, the output optical fiber 150₃ or 150₄. Similarly, the output beam 545o is focused by the second output ball lens 130o″, coinciding with the first input ball lens 130i′ in front of the waveguide g2 or g4 of the adjacent switch 105ᵢ or in front of the output optical fiber 150₁ or 150₂. The output optical beams 540o and 545o are coupled into the output optical fibers 150₁-150₄ (waveguide-to-fiber coupling) or into the waveguides g1-g4 of adjacent switches 105ᵢ, if the respective first output ball lenses 130o′ are aligned with the longitudinal axes thereof.

It is observed that in the bar configuration the direction of the output beams 540o and 545o does not deviate with respect of the direction of the input beams 530i and 535i.

FIG. 5B is a top view of the switch 105ᵢ in a so-called cross configuration. In the cross configuration the input optical signal is coupled into the waveguides g3 and/or g4; the cross configuration is obtained by a counterclockwise rotation of the switch 105ᵢ of an angle of 45° (or, alternatively, by a clockwise rotation of 135° as described above with reference to FIG. 2) with respect to the above-described bar configuration.

The input optical beam 530i, collimated by the ball lens 130i′, is focused by the second input ball lens 130i″, located in front of the waveguide g3 of the switch 105ᵢ, and, then, the first optical signal, carried by the input optical beam 530i, is coupled into the waveguide g3. The coupled optical signal travels through the guided path g3 inside the disk 110 towards the first output ball lens 130o′, placed in front of the end of the waveguide g3. By means of the aligned first and second output ball lenses 130o′ and 130o″ the first output optical signal, corresponding to the first input optical signal and carried by the output beam 545o emerging from the lens 130o′, is coupled into the output optical fiber 150₁, 150₂ or the waveguide g2, g4 of the adjacent switch 105ᵢ. Similarly, the second input optical signal carried by the optical beam 535ᵢ can be simultaneously coupled into the waveguide g4 and a corresponding second output signal carried by the output beam 540o is collimated by the output ball lenses 130o′ placed in front of the second end face of the waveguide g4. The output beam 540o can be focused by the second output ball lens 130o″, coinciding with the first input ball lens 130i′ in front of the waveguide g1, g3 of an adjacent switch 105ᵢ or, in case, of the output optical fiber 150₃, 150₄.

Differently from the bar configuration, in the cross configuration the direction of the output beam 540o, 545o forms an angle of 90° with respect to the direction of the corresponding input beam 535i, 530i. For bringing the switch 105ᵢ back to the bar configuration from the cross configuration, the switch 105ᵢ may be rotated clockwise of an angle of 45°.

The switch 105ᵢ can route two optical signals at the same time, the two optical signals being received by both the waveguide g1 and the waveguide g2 or by both the waveguide g3 and the waveguide g4. Depending on the position reached by the generic switch 105ᵢ, an optical signal is received by the waveguide g1 or g2 and does not deviate its direction, or, alternatively, is received by the waveguide g3 or g4 and deviates its direction of an angle of 90°.

Referring back to FIG. 1, optical signals are preferably fed to the switching system 100 by the input fibers 145₁ and 145₂, while the output fibers 150ᵢ and 150₂ collect the optical signals dynamically routed by the switching system 100. The input fibers 145₃ and 145₄ and the output fibers 150₃ and 150₄ can be, for example, exploited for monitoring the performances of the switching system 100. For example, if the switching system 100 is used in the context of a WDM network, each input fiber 145₁, 145₂ provides an optical signal of a respective WDM channel, the optical signals being preliminary separated by an optical multiplexer; similarly, each output fiber 150₁, 150₂ collects the optical signal of the desired WDM channel.

The arrangement of the switches 105ᵢ in the switching system 100 is such that it is possible, by means of the controlled rotation of the disks 110, to align a plurality of ball lenses 130 of the switches 105ᵢ and of the frame 135, so as to obtain a prevalently guided optical path from an input fiber 145₁, 145₂ to a chosen output fiber 150₁, 150₂. Each optical path is obtained by successive waveguide-to-waveguide couplings of the optical signal.

Let it be supposed that the optical signal propagated by the input fiber 145₁ has to be routed towards the output fiber 150₂, and, accordingly, the optical signal propagated by the input fiber 145₂ towards the output fiber 150₁. Considering the switch 105₁ in bar configuration, the ball lens 130 in front of the input fiber 145₁ is aligned with the longitudinal axis of the waveguide g1 of the switch 105₁ for coupling the received optical signal into the waveguide g1. The longitudinal axis of the waveguide g1 of the switch 105₁ has to be aligned with the longitudinal axis of the waveguide g3 of the switch 105₄, for coupling the optical signal into the waveguide g3 (the switch 105₄ is in cross configuration). Similarly, the optical signal is then coupled into the waveguide g2 of the switch 105₃, for being collected into the output fiber 150₂ (the switch 105₃ is in bar configuration). In this case, the switch 105₂ has to be in cross configuration for coupling the optical signal received from the input fiber 145₂ into the waveguide g3 and, then, into the output fiber 150₁.

It is observed that for obtaining the optical path between the input fiber 145₁ and the output fiber 150₂ it is sufficient to bring in cross configuration the switch 105ᵢ in the row of the matrix corresponding to the input optical fiber 145₁ and in the column corresponding to the output optical fiber 150₂ (in this case the switch 105₄). A similar consideration applies to the optical path between the input fiber 145₂ and the output fiber 150₁.

Alternatively, an optical path between the input fiber 145₁ and the output fiber 150₂ is obtained by the counterclockwise rotation of 45° of the switch 105₁ and of the switch 105₃ for reaching the cross configuration. In this case the optical signal from the input fiber 145₁ is coupled into the waveguide g3 of the switch 105₁, successively, into the waveguide g4 of the switch 105₂ and, then, into the waveguide g3 of the switch 105₃. The configuration of the switch 105₄ is not relevant.

In addition to the two above-considered optical paths from the input fibers 145₁ and 145₂ to the output fibers 150₂ and 150₁, respectively, two further alternative optical paths can be simultaneously configured in the switching system 100 from the input fibers 145₁ and 145₂ to the output fiber 150ᵢ and 150₂, respectively. In detail, the switches 105₁ and 105₃ have to be in cross configuration, while the switch 105₂ has to be in bar configuration. In this way, the optical signal from the input fiber 145₁ is coupled into the waveguide g3 of the switch 105₁, into the waveguide g2 of the switch 105₂ and, then, into the output fiber 150₁. Similarly, the optical signal from the input fiber 145₂ is coupled into the waveguide g1 of the switch 105₂, into the waveguide g3 of the switch 105₃ and, then, into the output fiber 150₂. Also in this case, the configuration of the switch 105₄ is not relevant.

It is observed that a number M (in the example M=2) of switches 105ᵢ in cross configuration is sufficient in a M×M matrix to obtain all the desired optical paths between the input optical fibers and the output optical fibers, particularly, it is sufficient having one switch in cross configuration in each row and column of the M×M matrix. In this way, for varying the optical paths of the signals inside the optical switching system it is required to actuate the movement of at most M+M switches. In detail, considering the worst case in which the optical paths of all the received signals have to be varied, for each row and column the switch previously in the cross configuration is brought in the bar configuration, while the switch corresponding to the new output of the signal, previously in the bar configuration, is brought in the cross configuration. As a consequence, the movement of at most two switches has to be actuated for each row and column irrespective of the matrix dimensions and, accordingly, the controllability of the optical switching system is very easy.

Similarly, for example when a monitoring has to be performed, input optical signals can be received also at the input fibers 145₃ and 145₄ and routed also towards the output optical fibers 150₃ and 150₄. Alternatively, all the input and output optical fibers 145ᵢ and 150ᵢ can be exploited during operation of the switching system 100.

Furthermore, it has to be considered that the switching system 100 is bi-directional, i.e., the optical fibers 145₁-145₄ referred to as input optical fibers might be exploited as outputs of the switching system 100, and the optical fibers 150₁-150₄ referred to as output optical fibers might be exploited as inputs.

It is observed that the optical signal, before being coupled into a waveguide g1-g4 or into an output fibers 150₁-150₄, covers the short free-space paths between two ball lenses 130, i.e., free-space paths of only about tens of micrometers. In a free-space path of such a small length the power losses and the increase of the beam diameter of the optical signal are very low. Typically, the insertion losses undergone by an optical signal in a fiber-to-waveguide or a waveguide-to-waveguide coupling are of about fractions of dB.

Considering FIGS. 6A, 6B and 6C, an elevation sectional view and two top-plane views (at different height) of an opto-mechanical switching element 605 according to a preferred alternative embodiment of the present invention are shown.

According to this preferred embodiment, each switch 605 comprises a block 610, preferably, of silicon for carrying an integrated optics guiding structure, and an electro-mechanical driving arrangement adapted to actuate a vertical translation of the switch 605 (as described in the following).

Similarly to the previously described embodiment, the integrated optics guiding structure of the switches 605 includes four waveguides g1, g2, g3 and g4, which are in this case arranged on two different longitudinal planes of the block 610. The waveguides g1 and g2 lie in an upper plane with respect to the plane of the waveguides g3 and g4; the waveguides g1 and g2 are substantially straight and orthogonal to each other, the waveguides g3 and g4 are bent and do not intersect. Each waveguide g1-g4 has a first end face and a second end face disposed on the edge of the block 610. In particular, the first end faces of the waveguides g1 and g3 are on a first side face of the block 610, while the first end faces of the waveguides g2 and g4 are on a second side face consecutive to the first side. The second end faces of the waveguide g1 and g4 are on a third side face of the block 610 opposite to the first side, while the second end faces of the waveguides g2 and g3 is on a fourth side face. The waveguides g1, g2, g3 and g4 have the first and the second end face on the median of the respective side of the block 610.

The integrated optics guiding structure, integrated in the block 610, is formed on a substrate 611, preferably, of silicon. A lower cladding 612, for example, of silica is directly laying on the substrate 611 and a core 615 of the waveguides g3 and g4 is formed on the lower cladding 612. A first thick upper cladding 620 covers the whole of the lower cladding 612 and the core 615, and a core 622 of the waveguides g1 and g2 is formed on the first upper cladding 612; a second upper cladding 630 covers the whole integrated optics guiding structure. Two magnets 635 are associated, for example, with the top and the bottom faces of the block 610, respectively. Alternatively, only one magnet 635 is placed in the substrate 611 in a suitable position intermediate between the top and the bottom faces of the block 610, e.g. in correspondence of the center of the block 610 (as illustrated in dash-and-dot lines in FIG. 6A).

The fabrication process is executed on a wafer, preferably, of silicon, similarly to the process described with reference to the embodiment of FIGS. 1-5B. In this case, the core 615 of the waveguides g3 and g4 and the core 622 of the waveguides g1 and g2 are formed in different stages of the fabrication process. In particular, the core 622 of the waveguides g1 and g2 is formed on the first upper cladding 620 of the waveguides g3 and g4, if necessary, after a planarization of the first upper cladding 620 (for example, by a Chemical-Mechanical Planarization process), and the second upper cladding 630 is realized by deposing an additional silica layer. Those skilled in the art will recognize that the upper cladding 620 has to be of a thickness sufficient to decouple the optical signals traveling through the waveguides g1, g2, g3 and g4 of the two different planes. Finally, a layer of ferromagnetic material is deposited over the block 610 for obtaining the magnet 635 centered with respect to the top face of the block 610.

The mechanical arrangement of a switch 605 cooperates with a frame 645, similar to that described with reference to FIGS. 1-2. The block 610 is inserted in a respective, e.g. cylindrical, sliding seat 690 formed in the frame 645, in which the block 610 is axially slidable guided by the walls of the seat 690.

As shown in FIGS. 6B-6C, four axial grooves 655 extend longitudinally at the periphery of the block 610. The whole structure is immersed in a matching fluid, such as glycerin, that fills the not occupied space of the seat 690; the matching fluid has a refractive index close to that of the guiding structure materials, for limiting the losses incurred during waveguide-to-fiber and waveguide-to-waveguide couplings of the optical signals. Moreover, the matching fluid acts also as lubricant for the movement of the block 610 inside the hollow volume and the grooves 655 permits to the matching fluid to flow freely. It has to be observed that the use of a matching fluid and, if necessary, of waveguides having tapered ending portions allows avoiding the exploitation of optics, such as lenses, for coupling optical signals into the waveguides and optical fibers.

Two electromagnets 650, each one in front of a respective magnet 635, are aligned to the axis of the block 610. The translational movement of the switch 605 along the axis of the block 610 is actuated by switching one electromagnet 635 at the time depending of the desired direction, thus attracting the magnets 635 associated with the block 610. The translational movement of the switch 605 is such that the optical signal can be coupled from the waveguides g1, g2, g3 and g4 of a switch 605 into the selected waveguides g1, g2, g3 and g4 of adjacent switches 605. A rod 665 is properly inserted into the block 610 for cooperating to guiding the movement of the block 610 into the direction parallel to the axis thereof.

However, the concepts of the present invention apply also when the block of the switch has a different shape, and particularly a different cross section, when the grooves are different in number and when the mechanical arrangement includes more than one rod. Alternatively, the translational movement is actuated in a way different from an electromagnetic actuation, for example by an electromechanical actuation other than electromagnetic, or in a way altogether different from an electromechanical actuation.

It can be appreciated that the present invention provides a switching system of simple implementation thanks to the use of standard technologies.

The easy controllability of the switching system according to the present invention is due to the simple architecture of the integrated optics guiding structure of the switches permitting both a bar and a cross configuration. The architecture of the integrated optics guiding structure of each switch permits a deviation of the optical signals of an angle of 90° and a switching system comprising a two-dimensional arrangement of such switches results very flexible.

Furthermore, this simple architecture of the integrated optics guiding structure of the switches is not a limit for the scalability of the switching system, since millimetric sizes of the switches are possible and, in addition, two different optical signals at the time can be coupled into the waveguides of each switch. The switching system permits a high scalability also thanks to that prevalently guided paths are encountered by the optical signals.

Naturally, in order to satisfy specific requirements, a person skilled in the art may apply to the solution described above many modifications and alterations all of which, however, are included within the scope of protection of the invention as defined by the following claims.

1-11. (canceled)

12. An optical switching system, comprising a two-dimensional arrangement of a plurality of switching elements adapted to routing a plurality of optical signals provided at inputs of the optical switching system toward respective outputs of the optical switching system, wherein each switching element comprises:
an optical guiding structure comprising two pairs of waveguides, each waveguide having an input and an output end faces;
a driving arrangement for individually moving the switching elements between at least a first and a second position; and
a first and a second input couplable to said input end faces, and a first and a second output couplable to said output end faces, each of said first and second inputs being optically coupled to either an input of the switching system or an output of an adjacent switching element, and each of said first and second outputs being optically coupled to either an output of the switching system or an input of a further adjacent switching element, wherein:
when a generic switching element is moved in the first position:
the first input is coupled to the input end face of a first waveguide of the two pairs of waveguides, and the first output is coupled to the output end face of the first waveguide, whereby an optical signal received at the first input is routed to the first output; and
the second input is coupled to the input end face of a second waveguide of the two pairs of waveguides, and the second output is coupled to the output end face of the second waveguide, whereby an optical signal received at the second input is routed to the second output, and
when a generic switching element is moved in the second position:
the first input is coupled to the input end face of a third waveguide of the two pairs of waveguides, and the second output is coupled to the output end face of the third waveguide, whereby an optical signal received at the first input is routed to the second output; and
the second input is coupled to the input end face of a fourth waveguide of the two pairs of waveguides, and the first output is coupled to the output end face of the fourth waveguide, whereby an optical signal received at the second input is routed to the first output,
the first, second, third and fourth waveguides being integrated optical waveguides, and
the two-dimensional arrangement being a matrix arrangement with a number of rows of switching elements and a number of corresponding columns of switching elements, the first input of a generic switching element being optically coupled to either an input of the switching system or the first output of a switching element of a same row, and the second input of a generic switching element being optically coupled to either a further input of the switching system or the second output of a switching element of a same column.

13. The optical switching system according to claim 12, wherein the plurality of optical signals is provided by first optical elements, each first optical element being coupled to one respective input of the optical switching system, and the plurality of optical signals routed toward the outputs of the optical switching system is received by second optical elements, each second optical element being coupled to one respective output of the optical switching system.

14. The optical switching system according to claim 12, wherein each switching element further comprises one optical device coupled to at least one among the first and second end faces of the first, second, third and fourth waveguides for focusing/collimating an optical signal.

15. The optical switching system according to claim 14, wherein the switching system comprises a further optical device coupled to at least one among the first and second optical elements for focusing/collimating an optical signal.

16. The optical switching system according to claim 12, further comprising a control unit for dynamically controlling the driving arrangement of the plurality of switching elements.

17. The optical switching system according to claim 12, wherein the two pairs of waveguides of the switching elements lie in a same plane and the driving arrangement causes the optical guiding structure to rotate about an axis of the plane for moving the respective switching element between the first or the second positions.

18. The optical switching system according to claim 17, wherein the input and output end faces of the first, second, third and fourth waveguides of each switching element are angularly separated by approximately 45°.

19. The optical switching system according to claim 12, wherein the first and second waveguides of the switching elements lie in a first plane and the third and fourth waveguides lie in a second plane, the first and second planes being parallel, and the driving arrangement causes the optical guiding structure to translate perpendicularly to the two planes for moving the respective switching element between the first and the second position.

20. The optical switching system according to claim 12, wherein the arrangement of the plurality of switching elements is accommodated in a box-shaped housing.

21. The optical switching system according to claim 20, wherein the box-shaped housing comprises grooves for receiving the first and the second optical elements.

22. An optical communications network node capable of receiving a plurality of optical signals, each node provided with a respective input of an optical switching system, comprising the optical system according to claim 12, the optical switching system routing each received optical signal toward a respective output of the optical switching system.
